(19) United States
(12) Patent Application Publication
(10) Pub. No.: US 2007/0265918 A1
(43) Pub. Date: Nov. 15, 2007

(54) System and method for tracking, auditing, and valuing online advertising

(76) Inventors: Michael Brent McMahon, Atlanta, GA (US); Donald F. Willis JR., Atlanta, GA (US); Daniel Jen Gonzalez, Decatur, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/712,842

(22) Filed: Mar. 1, 2007

Related U.S. Application Data
(60) Provisional application No. 60/778,092, filed on Mar. 2, 2006.

(51) Int. Cl. G06Q 30/00

(52) U.S. Cl. 705/14

(57) ABSTRACT

Systems and methods are disclosed for embodiments of the invention provide improved systems and methods for evaluating electronic advertisements. In one respect, embodiments of the invention provide a more accurate measure of the effectiveness of electronic advertisements under test conditions. In another respect, embodiments of the invention enable more accurate economic valuations of electronic advertisements. In yet another respect, embodiments of the invention provide improved auditing tools that could be used to evaluate the effectiveness of electronic advertisements in the marketplace.

This application claims priority to and the benefit of the filing date of U.S. Provisional Patent Application No. 60/778,092, filed Mar. 2, 2006, which is herein incorporated by reference in its entirety.

### TECHNICAL FIELD

This disclosure relates generally to data processing systems and methods, and more particularly, but without limitation, to systems and methods related to electronic advertising.

### BACKGROUND

Electronic advertisements may be delivered via Web pages, electronic messaging applications, or through other electronic applications. In the electronic advertising industry, the effectiveness of such electronic advertisements are typically measured using one of three alternative methods. A first method measures the number of unique users that are exposed to the advertisement. The resulting unit of valuation for this first method is typically Cost Per Mille (cost per one thousand impressions, or CPM). A second method measures a total number of mouse clicks (user selections) that are received in response to the advertisement, for a Cost-Per-Click (CPC) valuation. A third method measures the quantity of predetermined actions (such as a resulting registration, opt-in, or sale) for a Cost-Per-Action (CPA) valuation.

Known systems and methods for measuring and valuing electronic advertisements have many disadvantages, however. For instance, Web page “impressions” used in CPM valuations measure mere exposure, rather than the interest and attention of the recipient. Clicks that are counted in developing CPC valuations indicate that a recipient has reacted to the electronic advertisement, but don't provide useful information about the level or substance of the recipient's interaction. Finally, actions counted for CPA valuations don't provide any information about how a recipient interacted with the electronic advertisement itself. Accordingly, the usefulness of known CPM, CPC, and CPA valuations are limited.

### SUMMARY OF THE INVENTION

Embodiments of the invention seek to overcome one or more of the disadvantages described above by providing improved systems and methods for evaluating electronic advertisements.

Embodiments of the invention provide many benefits. In one respect, embodiments of the invention provide a more accurate measure of the effectiveness of electronic advertisements under test conditions. Such improved measures may, among other things, better inform the development process for electronic advertisements. In another respect, embodiments of the invention enable more accurate economic valuations of electronic advertisements. In yet another respect, embodiments of the invention provide improved auditing tools that could be used to evaluate the effectiveness of electronic advertisements in the marketplace.

An embodiment of the invention provides a method for rating the effectiveness of an electronic advertisement, including: starting a timer in response to delivery of the electronic advertisement; determining whether an interaction between a recipient and the electronic advertisement is complete; stopping the timer if the interaction is complete; and calculating a screen view time for the electronic advertisement based on the starling and the stopping.

An embodiment of the invention provides a method for rating the effectiveness of an electronic advertisement, the electronic advertisement having a plurality of interaction areas, the method including: determining whether a recipient of the electronic advertisement interacts with a each of a plurality of predetermined interaction areas in the electronic advertisement; and calculating a percentage of interaction value based on the determining.

An embodiment of the invention provides a method for rating the effectiveness of an electronic advertisement, the electronic advertisement being a multi-brand advertisement, including: calculating a duration rating associated with the electronic advertisement; calculating an engagement rating associated with the electronic advertisement; calculating an overall effectiveness rating based on the duration rating and the engagement rating; and comparing the overall effectiveness rating of the multi-brand advertisement to an overall effectiveness rating for a single-brand advertisement.

Embodiments of the invention also provide a processor-readable medium having stored thereon instructions for executing one or more of the aforementioned methods.

The invention will now be described with respect to exemplary embodiments illustrated in the drawings and discussed in the detailed description.

### BRIEF DESCRIPTION OF THE DRAWINGS

FIG. 1 is a block diagram of a functional architecture for a client-server network, according to an embodiment of the invention;

FIG. 2 is a sequence diagram of a client-server method, according to an embodiment of the invention;

FIG. 3 is flow diagram of a method for calculating a duration rating, according to an embodiment of the invention;

FIG. 4 is a flow diagram of a method for calculating an engagement rating, according to an embodiment of the invention;

FIG. 5 is a flow diagram of a method for calculating an overall effectiveness rating, according to an embodiment of the invention;

FIG. 6 is a flow diagram of a process for evaluating multi-brand advertising, according to an embodiment of the invention; and

FIG. 7 is a flow diagram of a method for evaluating the effectiveness of positioning for electronic advertisements, according to an embodiment of the invention.

### DETAILED DESCRIPTION

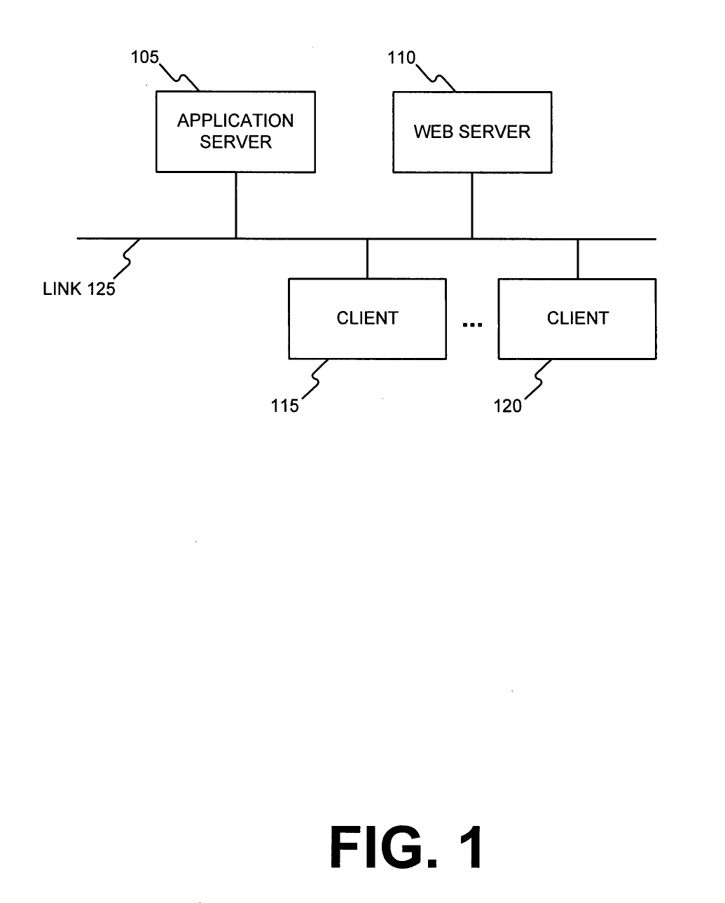

FIG. 1 is a block diagram of a functional architecture for a client-server network, according to an embodiment of the invention. An application server 105 and Web server 110 are coupled to clients 115 and 120 via link 125. Each of application server 105, Web server 110, client 115, and client 120 may be or include hardware, software, or a combination of hardware and software.

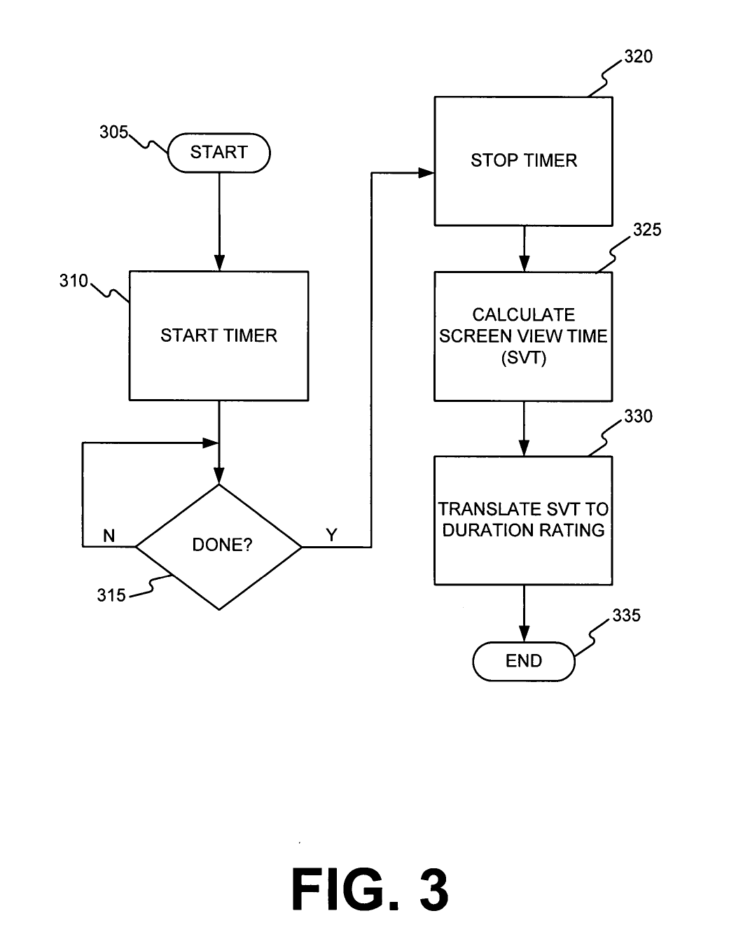

The application server 105 may include a processor, memory, an Operating System (OS), and/or application software. The processor may be configured to run an OS such as UNIX® FreeBSD®, Solaris™, Linux, or Microsoft Windows®. The application software may include processor-executable instructions for performing one or more methods described below with reference to FIGS. 3-7, or any portion of such methods.

The Web server 110 may likewise include a processor running an OS such as UNIX, FreeBSD, Solaris, Linux, or Microsoft Windows. In addition, the processor of Web server 110 may also be configured to execute a Web server program such as Apache Hyper-Text Transfer Protocol (HTTP) server, Microsoft Internet Information Services (IIS), Sun Java System Web Server, or Zeus Web Server.

Web server 110 may thus be configured to receive requests, for instance HTTP requests, from clients 115 and 120. Web server 110 may be further configured to serve Hyper-Text Mark-up Language (HTML) documents, data, or code to clients 115 and 120 in response to the HTTP requests. In addition, Web server 110 may be configured to send data logs to the application server 105 based on the received requests. The content delivered by the Web server 110 could be static, for example documents read from a memory, or could be dynamically created using script executed at the Web server 110. Web server 110 may further include computer memory (not shown) to store the OS, the Web server program, documents, data, scripts, and/or other code discussed above.

Clients 115 and 120 may each be a thick client (with robust processing capability), a thin client (having little or no native processing capability), or a rich client (a hybrid of thick and thin). For instance, client 115 and/or 120 may be or include a Personal Computer (PC), Personal Digital Assistant (PDA), Web-enabled telephone, or other device. Clients 115 and 120 may each include a processor, a memory, and an OS. Clients 115 and 120 may further include a browser, and electronic mail application, or other application software that can generate and transmit requests to the Web server 110 and receive responses from the Web server 110.

Link 125 may be or include the Internet or other network type, and in general may be or include any wired or wireless link. Accordingly, link 125 may utilize Internet Protocol (IP) or other communication protocol, according to application requirements.

Variations to the architecture illustrated in FIG. 1 are possible. For example, there may be more than one application server, more than one Web server, and/or any number of clients. Moreover, some or all functions of the application server 105 could be implemented in the Web server 110. Alternatively, at least some functions of the application server 105 could be executed in the clients 115 and 120.

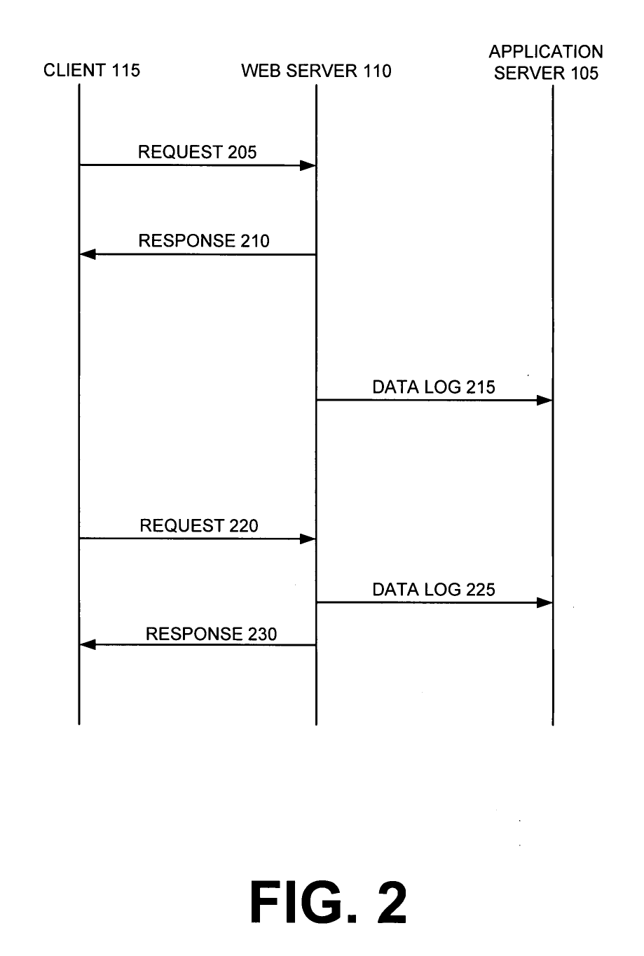

FIG. 2 is a sequence diagram of a client-server method, according to an embodiment of the invention. FIG. 2 illustrates communications between the client 115, Web server 110, and application server 105. In the illustrated embodiment, an initial request 205 is sent from the client 115 to the Web server 110. In response, the Web server 110 sends a response 210 to the client 115. For instance, the original request 205 could be a request from a browser operating at client 115 to the Web server 110 for Web page, and response 210 could represent delivery of a Web page to the client 115. As shown, the Web server 110 further sends data log 215 to the application server 105. Data log 215 is associated with the request 205. Data log 215 may indicate, for example, that the client 115 has requested a Web page containing an electronic advertisement.

In a subsequent exchange, the client 1 15 sends a request 220 to the Web server 110. In response, the Web server 110 first sends a data log 225 to the application server 105, then sends a response 230 from the Web server 110 to the client 115. The request 220 could be, for example, a request for data or code, the substance of which is supplied by the Web server 110 to the client 115 in response 230. Data log 225 is associated with the request 220. For instance, data log 225 could indicate that a client user has requested to play a media clip associated with an electronic advertisement.

The exchanges in FIG. 2 illustrate design choice with respect to data logging sequence. In the transaction set represented by request 205, response 210, and data log 215, data log 225 is performed subsequent to sending the response 210 to the client 115. By contrast, in the transaction set involving request 220, data log 225, and response 230, data log 225 is performed prior to sending a response 230.

Variations to the communications illustrated in FIG. 2 are possible. For example, in alternative embodiments. Data logs associated with multiple requests may be stored and aggregated at the client 1 15 and/or the Web server 1 10 before being forwarded to the application server 105. Storage and aggregation at the client might be appropriate where the client 115 is a thick client, where the client 115 is running local script that allows for certain types of user interactions without communication from the Web server 110, and/or where the link 125 is temporarily disrupted.

FIG. 3 is flow diagram of a method for calculating a duration rating, according to an embodiment of the invention. As illustrated in FIG. 3, the process begins in step 305, for example when a client requests a Web page containing an electronic advertisement. Step 305 may be triggered by a data log sent from the Web server 110 to the application server 105. Soon thereafter, a timer is started in step 310. Next, in conditional step 315, the process determines whether the user's interaction with the electronic advertisement is complete. A user interaction may be considered complete, for example, when the user requests a new Web page that does not contain any portion of the electronic advertisement. The triggering event for step 315 may also be based on a data log sent from the Web server 110 to the application server 105. Where such a triggering event occurs, the process is promoted to step 320, where the timer that was started in step 310 is stopped. Then, in step 325, the process calculates a Screen View Time (SVT) based on the start timer step 310 and the stop timer step 320. Next, the process translates the SVT to a duration rating in step 330 and terminates in step 335.

Notwithstanding the nomenclature, the SVT metric may represent impressions other than viewing; for instance, in some cases, SVT may represent the length of time a client user listened to an audio clip associated with an electronic advertisement.

Translation step 330 can take into account variation in the designed run-time of electronic advertisements. To illustrate the point, consider two motion graphics (MG) instances, where MG A has a designed run time of 30 seconds. MG B has a designed run-time of 60 seconds, and, in either case, the SVT calculated in step 325 is 20 seconds. As used herein, MG may refer to flash-based motion graphics, video clips, animation, or the like. Using Table 1 below, step 330 would translate a 20-second SVT to a duration rating of 7 for MG A, but only a duration rating of 4 for MG B. Thus, the translation step 330 may utilize a sliding scale that is proportional to the designed run time of the electronic advertisement.

TABLE 1

| SVT for MG A | SVT for MG B | Duration Rating |
|---|---|---|
| 1-3 sec | 1-6 sec | 1 |
| 4-6 sec | 7-12 sec | 2 |
| 7-9 sec | 13-18 sec | 3 |
| 10-12 sec | 19-24 sec | 4 |
| 13-15 sec | 25-30 sec | 5 |
| 16-18 sec | 31-36 sec | 6 |
| 19-21 sec | 37-42 sec | 7 |
| 22-24 sec | 43-48 sec | 8 |
| 25-27 sec | 49-54 sec | 9 |
| 28-30 sec | 55-60 sec | 10 |

Variations to the process illustrated in FIG. 3 are possible. For example, in applications where the designed run-time of electronic advertisements do not vary, translation step 330 may not be required. In addition, although Table 1 illustrates a linear relationship between SVT and the duration rating, non-linear relationships could be used according to design choice. Moreover, although the process is described above with respect to a single viewing of a single electronic advertisement, steps 305-325 could be repeated for multiple viewings of a given advertisement, and step 330 could use an average SVT to determine a duration rating. Alternatively, steps 305-335 could be repeated for multiple viewings of a given advertisement, and the resulting duration ratings could be averaged or subjected to statistical analysis.

It may be advantageous to measure the relative amount of user interaction with different portions of an electronic advertisement. To facilitate such analysis, an electronic advertisement can he logically segregated into multiple interaction areas. Interaction areas may be distinguished, for example, based on the type of user interaction (e.g., MG, audio clips, or textual inputs), the differences in substance between multiple interaction areas, or other criterion.

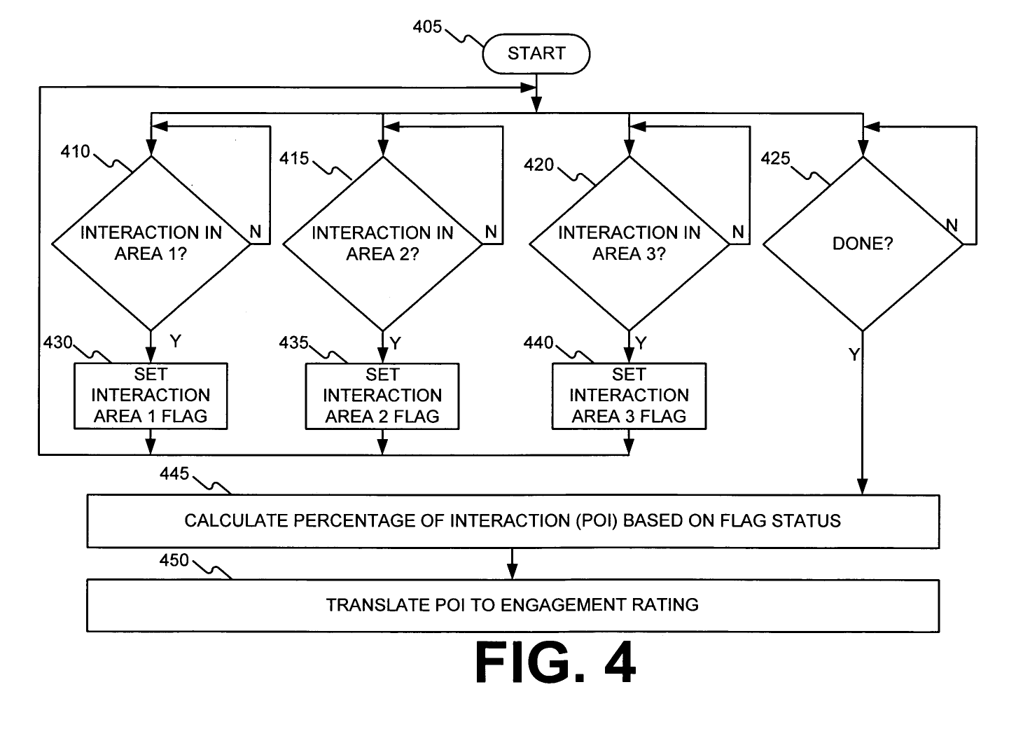

FIG. 4 is a flow diagram of a method for calculating an engagement rating, according to an embodiment of the invention. The process may begin in step 405, for example, when a client requests a Web page containing an electronic advertisement. Thereafter, the process simultaneously executes conditional steps 410, 415, 420, and 425. In each of steps 410, 415, 420, and 425, the process determines whether a user interaction has occurred in predetermined interaction areas 1, 2, or 3, respectively. The user interaction may be or include, for example, a client request to play a MG. a client request to play an audio clip, a client request for a Web page associated with the electronic advertisement, a client selecting a check box associated with an advertisement, setting a Web page bookmark, saving content from the advertisement to memory, or other monitored activity. The fact of such interaction may be reported in a data log sent from the Web server 1 10 to the application server 105.

If an interaction is detected in step 410, the process advances to step 430 to set the interaction area 1 flag, then returns to monitoring conditions 410, 415, 420, and 425. Likewise, where the result of conditional step 415 is affirmative. The process advances to step 435 to set the interaction area 2 flag, then return to monitoring each of conditions 410, 415, 420, and 425. In an affirmative response to conditional step 420, the process sets the interaction area 3 flag in step 440, then continues monitoring conditions 410, 415, 420, and 425. In the illustrated embodiment, each of interaction area flags 1, 2, and 3 have only two states: set, or un-set. The initial state is un-set. Once set, an interaction area flag cannot be un-set.

Conditional step 425 may be satisfied, for example, when an user requests a Web page that is not associated with the electronic advertisement. Where the result of conditional step 425 is negative, the process continues to monitor for each of conditions specified in steps 410, 415, 420, and 425. Where the condition of step 425 has been met, the process advances to step 445 to calculate a Percentage Of Interaction (POI) based on the status of interaction area flags 1, 2, and 3. Then, in step 450, the process translates the POI to an engagement rating.

Step 445 divides the total number of interaction area flags that are set by the total number of predefined interaction areas for the electronic advertisement. Thus, if only interaction area flags 1 and 2 are set prior to the condition of step 425 being satisfied, and if the electronic advertisement being monitored has only three interaction areas (as illustrated by the process in FIG. 4), then the POI is 213, or approximately 67%.

Translation step 450 can be performed according to the predefined relationship in Table 2, where the POI is rounded up to the next higher integer. Thus, for a POI of 67%, translation step 450 would result in an engagement rating of 7.

### OTHER EMBODIMENTS

It will be apparent to those skilled in the art that various modifications and variations can be made to the disclosed systems and methods. For instance processes described herein may be used in combinations not explicitly described. In addition, although systems and methods are described above with reference to Web-based electronic advertising applications, variations of the disclosed embodiments could also be applied to advertisements embedded in electronic mail messages. Accordingly, other embodiments will be apparent to those skilled in the art from consideration of the specification and practice of the disclosed system and methods. It is intended that the specification and examples be considered as exemplary only, with a true scope being indicated by the following claims and their equivalents.

TABLE 2

| Calculated POI | Engagement Rating |
|---|---|
| 0-10% | 1 |
| 11-20% | 2 |
| 21-30% | 3 |
| 31-40% | 4 |
| 41-50% | 5 |
| 51-60% | 6 |
| 61-70% | 7 |
| 71-80% | 8 |
| 81-90% | 9 |
| 91-100% | 10 |

Variations to the process illustrated in FIG. 4 are possible. For instance, although a linear relationship is provided by Table 2, translation step 450 could be performed based on a non-linear relationship between POI values and engagement ratings. In addition, instead of using interaction area flags; an alternative embodiment utilizes interaction area counters that increment each time an interaction in a given area is detected. In this case, a resulting POI could be greater than 100, altering the meaning of the POI metric and the engagement rating, and steps 445 and 450 may be omitted. Nevertheless, the collection and reporting of interaction area counts may be useful to a down-stream analysis of an advertising campaign.

An overall effectiveness rating that considers both SVT and interaction area activity can be calculated using the duration rating determined in step 330 and the engagement rating determined in step 450. In one embodiment, the duration rating and the engagement rating are multiplied to determine the overall effectiveness rating. Thus, for an electronic advertisement with a duration rating of 4 and an engagement rating of 7, the overall effectiveness rating is 28.

In alternative embodiments, the duration rating and the engagement rating could be added to arrive at an overall effectiveness rating. Moreover, where data from multiple presentations of a single electronic advertisement are being analyzed, an overall effectiveness calculation could be based on an average duration rating and an average engagement rating. Alternatively, overall effectiveness ratings could be calculated for each of multiple presentations of an electronic advertisement, and then the overall effectiveness ratings could be averaged to produce an average overall effectiveness rating.

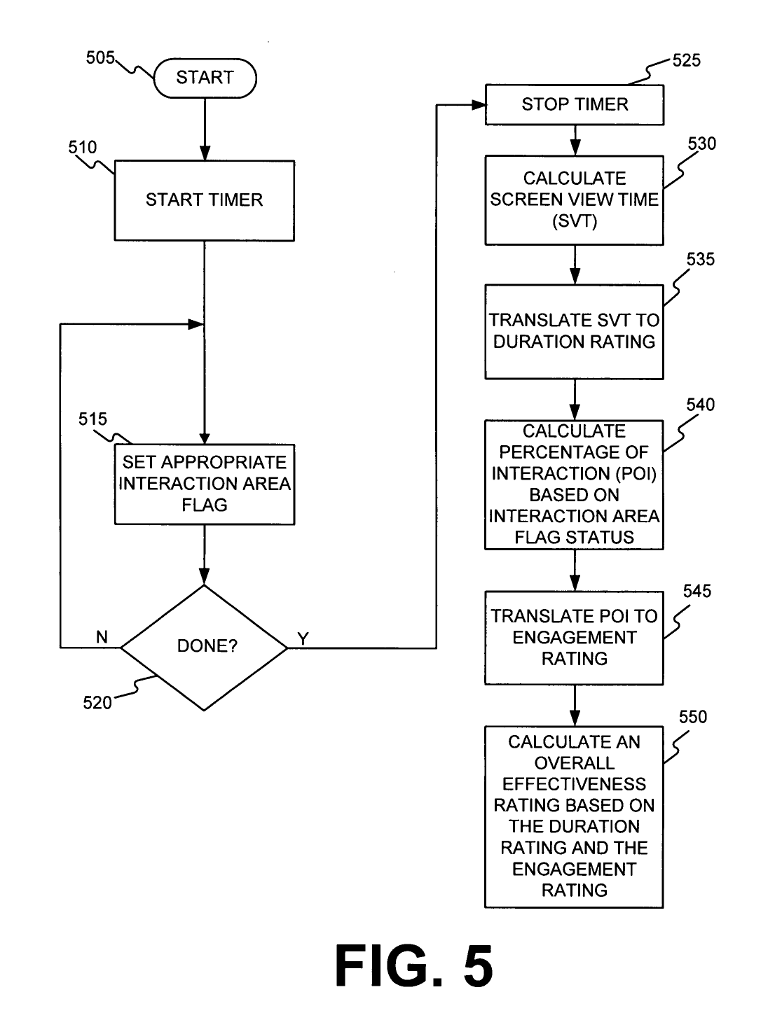

FIG. 5 is a flow diagram of a method for calculating an overall effectiveness rating, according to an embodiment of the invention. The process illustrated in FIG. 5 combines certain elements of FIGS. 3 and 4. As shown therein, the process begins in step 505, for instance, when a client requests a Web page containing an electronic advertisement. Next, a timer is started in step 510. Then, in step 515, the process sets appropriate interaction area flags based on predetermined interaction area definitions associated with the electronic advertisement and requests from a client user. In conditional step 520, the process determines whether the client user's interaction with the electronic advertisement is complete. This condition is satisfied, for example, where a client has requested a Web page that is not associated with the electronic advertisement. If the condition in step 520 has not been satisfied, the process returns to step 515 to monitor the interactions between the client user and the predetermined interaction areas of the electronic advertisement.

Where conditional step 520 has been satisfied, the process advances to step 525 to stop the timer. Next, in step 530; the process calculates a SVT based on the start timer step 510 and the stop timer step 525. In step 535, the process translates the SVT to a duration rating as described above with reference to step 330. In step 540, the process calculates a POI based on flag interaction area flags set in step 515, as described above with reference to step 445. The process then translates the POI to an engagement rating in step 545, as described above with reference to step 450. In optional step 550, the process calculates an overall effectiveness rating based on the duration rating and the engagement rating calculated in steps 535 and 545, respectively.

Variations to the process illustrated in FIG. 5 are possible. For instance, where an advertisement has been presented multiple times, an average duration rating and an average engagement rating can be used to calculate an overall effectiveness rating. Alternatively, multiple overall effectiveness ratings can be averaged to produce an average overall effectiveness rating.

As used herein, co-branding, multi-branding. or a multi-brand advertisement refer to the case where multiple product brands are advertised together in a single electronic advertisement. In one respect, it may be advantageous to compare the relative effectiveness of a multi-brand advertisement to a single-brand advertisement. In another respect, it may be advantageous to compare the relative effectiveness of different multi-brand advertisement combinations. In addition, it may be advantageous to compare the relative effectiveness of a multi-brand advertisement with respect to individual brands contained within the multi-brand advertisement.

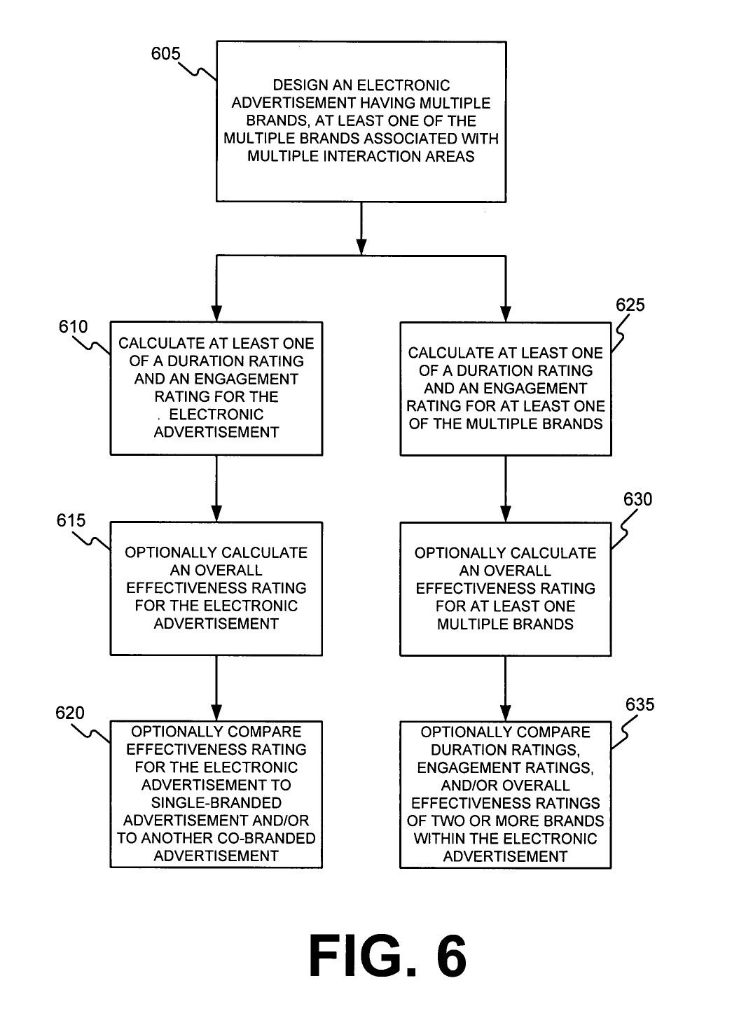

FIG. 6 is a flow diagram of a process for evaluating multi-brand advertising, according to an embodiment of the invention. In step 605, an electronic advertisement having multiple brands is designed, for example, as part of an advertising campaign. In the illustrated embodiment, the multi-brand advertisement includes at least one brand associated with multiple user interaction areas. Subsequent to step 605, the advertisement may be evaluated according to one, or both, illustrated branches. A first branch is illustrated with respect to steps 610, 615, and 620, and a second branch is illustrated with respect to steps 625, 630, and 635.

In step 610, the process calculates at least one of a duration rating and an engagement rating for the electronic advertisement. Next, in step 615, the process optionally calculates an overall effectiveness rating for the electronic advertisement. Step 610 may be performed using the processes illustrated in FIGS. 3 and/or 4, and steps 610 and/or 615 may be executed using the process (or portions thereof) described above with reference to FIG. 5.

In step 620, the process optionally compares the overall effectiveness rating for the electronic advertisement to a single branded advertisement and/or to another co-branded advertisement having different included brands.

In step 625, the process calculates at least one of a duration rating and an engagement rating for at least one brand in the multi-brand advertisement. Next in step 630, the process optionally calculates an overall effectiveness rating for at least one of the multiple brands. Step 625 may be performed using the processes illustrated in FIGS. 3 and/or 4, and steps 625 and/or 630 may be executed using the process (or portions thereof) described above with reference to FIG. 5. Then, in step 635, the process optionally compares the duration ratings, the engagement ratings, and/or the overall effectiveness rating of two or more brands within the multi-brand advertisement.

The effectiveness of electronic advertisements may vary according to positioning. As used herein, positioning distinctions may include. For instance, whether the electronic advertisement is placed between content or is instead embedded within content. Positioning may also refer to how deep within multiple pages of content the electronic advertisement is placed. Furthermore, positioning may refer to a local time of day that an electronic advertisement is presented. Thus, an electronic advertisement that runs mid-morning is positioned differently than an advertisement that runs in the early evening. The effectiveness of such positioning may be influenced, for example, by the demographic of a target audience.

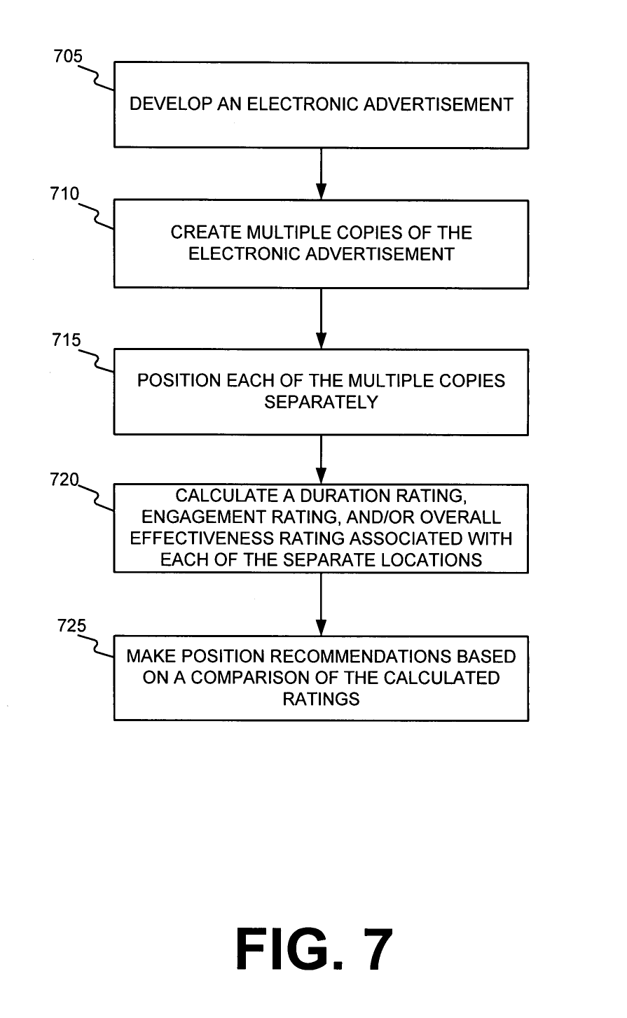

FIG. 7 is a flow diagram of a method for evaluating the relative effectiveness of alternative positioning for electronic advertisements, according to an embodiment of the invention. The process begins in step 705 with the development of an electronic advertisement, for example, as part of an advertising campaign. Next, in step 710, the process creates multiple copies of the electronic advertisement. In step 715, the process positions each of the multiple copies separately.

In step 720, the process calculates a duration rating, an engagement rating, and/or an overall effectiveness rating associated with each of the separately placed electronic advertisements. Step 720 may be performed using the processes (or portions thereof) described above with reference to FIGS. 3-5. Finally, in the step of 725, the process makes position recommendations based on a comparison of one or more of the ratings calculated in step 720. A higher rating results in a higher recommendation. In the alternative or in combination with step 725, the process could include a valuation step where a higher rating results in a higher valuation for the advertisement.

Variations to the process illustrated in FIG. 7 are possible. For example, an advertisement may he presented by rotating the advertisement through two or more positional alternatives. Such rotations may be predetermined or fixed. Accordingly, in an alternative embodiment, the process in FIG. 7 could be modified to measure the effectives of one advertisement rotation scheme (involving a first set of positions) as compared with another rotation scheme (involving a second set of positions).

The system described with reference to FIGS. 1 and 2 may be configured to perform one or more of the methods described above with reference to FIGS. 3-7. In addition, any one of the methods described with reference to FIGS. 3-7 may be performed in hardware, software, or a combination of hardware and software. Moreover, the methods described with reference to FIGS. 3-7, or any portion thereof, may be implemented by instructions that are stored on computer-readable medium so that the instructions can be read and executed by a processor.

What is claimed is:

1. A method for rating the effectiveness of an electronic advertisement, comprising:
starting a timer in response to delivery of the electronic advertisement;
determining whether an interaction between a recipient and the electronic advertisement is complete;
stopping the timer if the interaction is complete; and
calculating a screen view time for the electronic advertisement based on the starting and the stopping.

2. The method of claim 1, further comprising translating the screen view time to a duration rating based on a predefined relationship between a plurality of screen view times and a plurality of interaction duration ratings.

3. The method of claim 2, wherein the predetermined relationship between the plurality of screen view times and the plurality of duration ratings is linear.

4. The method of claim 2, wherein the predefined relationship between the plurality of screen view times and the plurality of duration ratings is based on a designed run time for the electronic advertisement.

5. The method of claim 2, further comprising:
setting at least one interaction area flag;
calculating a percentage of interaction based on the at least one interacting flag; and
translating the percentage of interaction to an engagement rating.

6. The method of claim 5, further comprising calculating an overall effectiveness rating based on the duration rating and the engagement rating.

7. A processor-readable medium having stored thereon instructions for executing a method for rating the effectiveness of an electronic advertisement, the method comprising:
starting a timer in response to delivery of the electronic advertisement;
determining whether an interaction between a recipient and the electronic advertisement is complete;
stopping the timer if the interaction is complete; and
calculating a screen view time for the electronic advertisement based on the starting and the stopping.

8. A method for rating the effectiveness of an electronic advertisement, the electronic advertisement having a plurality of interaction areas, the method comprising:
determining whether a recipient of the electronic advertisement interacts with a each of a plurality of predetermined interaction areas in the electronic advertisement; and
calculating a percentage of interaction value based on the determining.

9. The method of claim 8, further comprising translating the percentage of interaction value to an engagement rating based on a predefined relationship between a plurality of percentage of interaction values and a plurality of engagement ratings.

10. The method of claim 9, wherein the predefined relationship between the plurality of percentage of interaction values and the plurality of engagement ratings is linear.

11. A processor-readable medium having stored thereon instructions for executing a method for rating the effectiveness of an electronic advertisement, the method comprising:
determining whether a recipient of the electronic advertisement interacts with a each of a plurality of predetermined interaction areas in the electronic advertisement; and
calculating a percentage of interaction value based on the determining.

12. A method for rating the effectiveness of an electronic advertisement, the electronic advertisement being a multi-brand advertisement, comprising:
calculating a duration rating associated with the electronic advertisement;
calculating an engagement rating associated with the electronic advertisement;
calculating an overall effectiveness rating based on the duration rating and the engagement rating; and
comparing the overall effectiveness rating of the multi-brand advertisement to an overall effectiveness rating for a single-brand advertisement.
